(19) United States
(12) Patent Application Publication
(10) Pub. No.: US 2021/0223455 A1
(43) Pub. Date: Jul. 22, 2021

(54) BACKLIGHT MODULE AND DISPLAY APPARATUS

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Sen TAN, Beijing (CN); Qiangsheng HAN, Beijing (CN)

(21) Appl. No.: 16/099,255

(22) PCT Filed: Feb. 11, 2018
(86) PCT No.: PCT/CN2018/076191

§ 371 Date: Nov. 6, 2018

(30) Foreign Application Priority Data
Jul. 3, 2017 (CN) 201710534266.8

(51) Int. Cl. F21V 8/00

(52) U.S. Cl. CPC G02B 6/0021; G02B 6/0055; G02B 6/0058; G02B 6/0043

(57) ABSTRACT

Embodiments of the present disclosure provide a backlight module and a display apparatus. The backlight module includes: a light guide plate, including a first main surface and a second main surface being opposite to each other; and at least one light-emitting unit, arranged on a side of the first main surface of the light guide plate, wherein at least one groove is disposed on a side of the light guide plate positioned on the first main surface, and at least one light-emitting unit is arranged in each of the groove.

The present application claims priority of Chinese Patent Application No. 201710534266.8 filed on Jul. 3, 2017, the disclosure of which are incorporated herein by its reference in its entirety as part of the present application.

### TECHNICAL FIELD

At least one embodiment of the present disclosure relates to a backlight module and a display apparatus.

### BACKGROUND

In a current backlight module, a great number of light sources are used, which may make a region of the backlight module, which is used for installing the light sources, complex in structure and increase difficulty in technical processes such as manufacturing and assembling of the backlight module. In addition, for a current backlight module structure, a utilization rate of light emitted by the light sources is low, so that the product is poor in display effect and high in power consumption.

### SUMMARY

At least one embodiment of the present disclosure provides a backlight module, and the backlight module comprises: a light guide plate, including a first main surface and a second main surface being opposite to each other; and at least one light-emitting unit, arranged on a side of the first main surface of the light guide plate, wherein at least one groove is disposed on a side of the light guide plate positioned on the first main surface, and at least one light-emitting unit is arranged in each of the groove.

For example, in the backlight module provided by at least one embodiment of the present disclosure, a shape of the light guide plate is one of circle, triangle, rectangle and polygon.

For example, in the backlight module provided by at least one embodiment of the present disclosure, one of the grooves is disposed at a shape center of the light guide plate; and/or at least two of the grooves are symmetrically disposed with respect to the shape center of the light guide plate.

For example, in the backlight module provided by at least one embodiment of the present disclosure, the light guide plate is of a circle shape, and the groove is positioned at a circle center of the first main surface of the light guide plate.

For example, in the backlight module provided by at least one embodiment of the present disclosure, in a direction perpendicular to the first main surface, a shape of a cross section of the groove is a circular arc or an elliptic arc.

For example, in the backlight module provided by at least one embodiment of the present disclosure, the light-emitting unit is a Light-Emitting diode (LED).

For example, the backlight module provided by at least one embodiment of the present disclosure further comprises a plurality of dots, disposed on the first main surface of the light guide plate and/or a surface of the groove.

For example, in the backlight module provided by at least one embodiment of the present disclosure, diameters of the plurality of dots on the first main surface increase as distances from the groove increase; and/or a distribution density of the plurality of dots on the first main surface increases as the distances from the groove increase.

For example, in the backlight module provided by at least one embodiment of the present disclosure, a distribution density of the dots on the surface of the groove is greater than a distribution density of the dots on the first main surface.

For example, in the backlight module provided by at least one embodiment of the present disclosure, a concave-convex structure is arranged at a position on the second main surface of the light guide plate being opposite to the groove.

For example, the backlight module provided by at least one embodiment of the present disclosure further comprises a reflection layer, arranged on a side of the first main surface of the light guide plate, wherein the reflection layer is provided with at least one opening, and the opening is configured to expose the groove.

For example, the backlight module provided by at least one embodiment of the present disclosure further comprises an adhesive layer, arranged on a side of the first main surface of the light guide plate, wherein a refractive index of the adhesive layer is lower than a refractive index of the light guide plate.

At least one embodiment of the present disclosure provides a display apparatus, comprising the backlight module according to any one of the above mentioned embodiments.

For example, the display apparatus provided by at least one embodiment of the present disclosure further comprises: a display panel, arranged on a light emergent side of the backlight module, wherein the display panel includes both a lower surface and an upper surface opposite to each other, and the lower surface of the display panel faces the backlight module.

For example, the display apparatus provided by at least one embodiment of the present disclosure further comprises: a backplate, configured to support the backlight module and the display panel; and a light shielding tape, configured to fix the display panel and the backlight module, wherein the light shielding tape includes a ring-shaped main body and a plurality of side portions connected with an outer edge of the main body and arranged at intervals, the main body is bonded to an edge portion of an upper surface of the display panel, and the side portions are bonded to the backplate.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention

FIG. 1 is a structural schematic diagram of a backlight module provided by an embodiment of the present disclosure;

FIG. 2 is a bottom view of a light guide plate in a backlight module provided by an embodiment of the present disclosure;

FIG. 3a is another structural schematic diagram of a backlight module provided by an embodiment of the present disclosure;

FIG. 3b is a schematic diagram of distribution of dots in the backlight module as shown in FIG. 3a on a light guide plate;

FIG. 4 is yet another structural schematic diagram of a backlight module provided by an embodiment of the present disclosure;

FIG. 5 is still a further structural schematic diagram of a backlight module provided by an embodiment of the present disclosure;

FIG. 6 is a structural schematic diagram of a display apparatus provided by an embodiment of the present disclosure; and

FIG. 7 is a structural schematic diagram of a light shielding tape in the display apparatus as shown in FIG. 6.

### REFERENCE SIGNS

100—light guide plate; 110—first main surface; 120—second main surface; 130—groove; 140—central region; 150—concave-convex structure; 200—light-emitting unit; 300—dot; 400—reflection layer; 410—opening; 500—adhesive layer; 600—light extraction film; 610—microprotrusion structure; 700—optical film sheet; 800—display panel; 900—backplate; 910—sealant; 1000—light shielding tape; 1100—main body; 1200—side portion.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” or the like are only used to indicate relative position relationship, and when the position of the object which is described is changed, the relative position relationship may be changed accordingly.

Due to the limitation to the design structure of a current backlight module, a utilization rate of light emitted by a light source is low, so that the product is poor in display effect, high in power consumption and complex in installation process. Taking a case that a light incident mode of the backlight module is a edge mode as an example, in order to avoid a Hotspot phenomenon, a great number of light sources are installed on a light bar, so that a region where the light bar is installed is complex in structure, thereby increasing difficulty in manufacturing and installing the backlight module. Taking a case that the light incident mode of the backlight module is a direct mode as an example, it also requires a great number of light sources to ensure uniformity of light emission, and the backlight module adopting such design structure is relatively large in thickness, which is not beneficial to lightening and thinning of the product.

At least one embodiment of the present disclosure provides a backlight module and a display apparatus, which can solve the above-mentioned technical problems. In the backlight module according to at least one embodiment, a light-emitting unit is arranged in a groove of a light guide plate, so that the Hotspot phenomenon does not need to be considered, and thus, the number of the light-emitting units being used can be reduced; moreover, the design mode enables light emitted by the light-emitting unit to directly enter the light guide plate, so that the utilization rate of the light emitted by the light-emitting unit can be improved; and in addition, the light-emitting unit is arranged in the groove of the light guide plate without occupying an additional design space, so that a thickness of an overall display module can be reduced and cost can be reduced.

The backlight module and the display apparatus according to at least one embodiment of the present disclosure will be described in detail below in connection with the drawings.

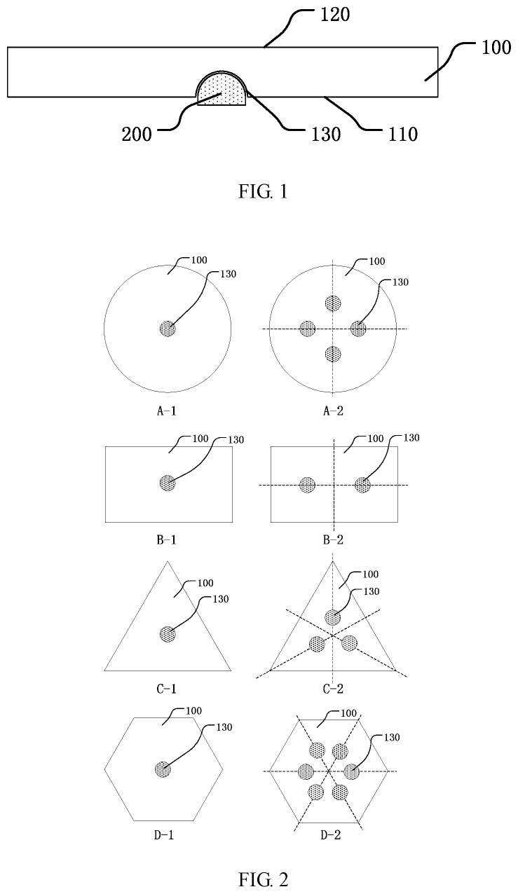

At least one embodiment of the present disclosure provides a backlight module, and FIG. 1 is a sectional structural schematic diagram of a backlight module provided by an embodiment of the present disclosure. For example, as shown in FIG. 1, the backlight module includes a light guide plate 100 and a light-emitting unit 200, wherein the light guide plate 100 includes a first main surface 110 and a second main surface 120 which are opposite; at least one groove 130 is disposed on a side of the light guide plate 100, which is positioned on the first main surface 110; and at least one light-emitting unit 200 is arranged in each groove 130. For example, in the embodiments of the present disclosure, the light-emitting unit 200 may include at least one Light-Emitting diode (LED) or an Organic Light-Emitting diode (OLED) and the like. In at least one embodiment of the present disclosure, the type of the light-emitting unit 200 is not limited, as long as the light-emitting unit 200 may be set as a point light source. After entering the light guide plate 200, light emitted by the light-emitting unit 200 is dispersed in the light guide plate 200 and emits out from the second main surface 120 of the light guide plate 200.

In at least one embodiment of the present disclosure, a size of the groove 130 is not limited, as long as the groove 130 may accommodate the light-emitting unit 200 and does not affect optical performance of the light guide plate 100. For example, in a direction perpendicular to a surface where the light guide plate 100 is positioned, a depth of the groove 130 may be set as about ⅓ to ⅔ of a thickness of the light guide plate 100, and for example, further may be ½ of the thickness of the light guide plate 100 and the like. Therefore, it can be avoided that due to the excessive depth of the groove 130, strength of the light guide plate 100 is affected, and it can be prevented that due to a too small thickness of a portion of the light guide plate 100, which corresponds to the groove 130, excessive light is transmitted at the position so as to affect uniformity of light emission of the light guide plate 100. For example, in a direction in parallel to the surface where the light guide plate 100 is positioned, a diameter range of the groove 130 may be set as 3 to 8 mm, and for example, 5 mm, so that the light-emitting unit 200 is embedded into the light guide plate 100.

For example, in at least one embodiment of the present disclosure, a preparation material of the light guide plate 100 may be a material with excellent light transmittance, and the material for preparing the light guide plate 100, for example, may include glass, polyethylene terephthalate (PET), polymethyl methacrylate (PMMA) or a methyl methacrylate and styrol copolymer (MS) and the like.

In at least one embodiment of the present disclosure, a mode of forming the groove 130 in the light guide plate 100 is not limited. For example, the light guide plate 100 may be formed by injection molding, so that in the process of preparing the light guide plate 100, the groove 130 is formed; and for example, the groove 130 may also be formed on a side of the first main surface 110 of the light guide plate 100 by methods, such as hot pressing and the like, after the light guide plate 100 is prepared.

In at least one embodiment of the present disclosure, the arrangement number of the grooves 130 on the light guide plate 100 is not limited, and one or more grooves 130 may be formed; and moreover, the number of the light-emitting units 200 arranged in each groove 130 is not limited, and one or more light-emitting units 200 may be arranged in each groove 130. In at least one embodiment of the present disclosure, a light-emitting unit 200 with a large emission angle may be selected as a light source, so as to improve a dispersion degree of the light emitted by the light-emitting unit 200 in the light guide plate 100. Taking a case of arranging one light-emitting unit 200 in each groove 130 as an example, the technical solution in the under-mentioned at least one embodiment of the present disclosure will be illustrated below.

For example, in at least one embodiment of the present disclosure, a shape of a cross section of the groove 130 in the light guide plate 100 is not limited. For example, in a direction perpendicular to the first main surface 100, the shape of the cross section of the groove 130 may be a circular arc or an elliptic arc and the like.

For example, in at least one embodiment of the present disclosure, a shape of the light guide plate 100 (which is equivalent to a shape of the second main surface 120 of the light guide plate 100) is not limited. For example, the shape of the light guide plate 100 may be one of circle, triangle, rectangle, polygon and the like.

FIG. 2 is a bottom view of a light guide plate in a backlight module provided by an embodiment of the present disclosure. For example, in a backlight module provided by at least one embodiment of the present disclosure, as shown in FIG. 2, the light guide plate 100 may be of various shapes. A circular light guide plate 100 is as shown in FIG. 2(A-1) and FIG. 2(A-2), a rectangular light guide plate 100 is as shown in FIG. 2(B-1) and FIG. 2(B-2), a triangular light guide plate 100 is as shown in FIG. 2(C-1) and FIG. 2(C-2), and a polygonal (for example, orthohexagonal) light guide plate 100 is as shown in FIG. 2(D-1) and FIG. 2(D-2).

For example, in at least one embodiment of the present disclosure, a specific arrangement position of the groove 130 in the light guide plate 100 is not limited, as long as the groove 130 may enable the light emitted by the light-emitting unit 200 to enter the light guide plate 100. For example, in at least one embodiment of the present disclosure, as shown in FIG. 2, one of the grooves 130 is formed at a shape center of the light guide plate 100; and/or at least two of the grooves 130 are symmetrically formed with respect to the shape center of the light guide plate 100, so that the degree of uniform distribution of the light emitted by the light-emitting unit 200 in the light guide plate 100 can be improved, thereby improving uniformity of light emission of the light guide plate 100.

It should be noted that in at least one embodiment of the present disclosure, the number and the symmetrical mode of the grooves 130 symmetrically disposed with respect to the shape center (which is not shown in the drawings, for example, a position where dotted lines intersect in FIG. 2) of the light guide plate 100 are not limited, as long as distribution of the grooves 130 can improve uniformity of light emission of the light guide plate 100. as shown in FIG. 2(A-2), FIG. 2(B-2), FIG. 2(C-2) and FIG. 2(D-2) in FIG. 2, the number of the grooves 130 symmetrically disposed with respect to the shape center of the light guide plate 100 may be two or more than two, and the grooves 130 may be centrally symmetrically disposed or axially symmetrically disposed with respect to the shape center of the light guide plate 100.

For example, in at least one embodiment of the present disclosure, as shown in FIG. 2(A-1), the light guide plate 100 is of a circle shape, and the groove 130 is positioned at a circle center of the first main surface 110 of the light guide plate 100. Therefore, only one light-emitting unit 200 with high power needs to be arranged at the circle center of the light guide plate 100, so that the number of the light-emitting units 200 being used is reduced; moreover, the backlight module with the structure does not require a complex structure to fix the light-emitting unit 200, so that difficulties of a production process and assembling of the backlight module can be reduced; and in addition, the light-emitting unit 200 is arranged at the circle center of the light guide plate 100, so that emergent light of the light-emitting unit 200 can be uniformly distributed in the light guide plate 100, and uniformity of light emission of the light guide plate 100 is improved.

Taking a case that the light guide plate 100 is of a circle shape as shown in FIG. 2(A-1) and one groove 130 is formed and positioned at the circle enter of the first main surface 110 of the light guide plate 100 as an example, the technical solution in the under-mentioned at least one embodiment of the present disclosure will be illustrated below.

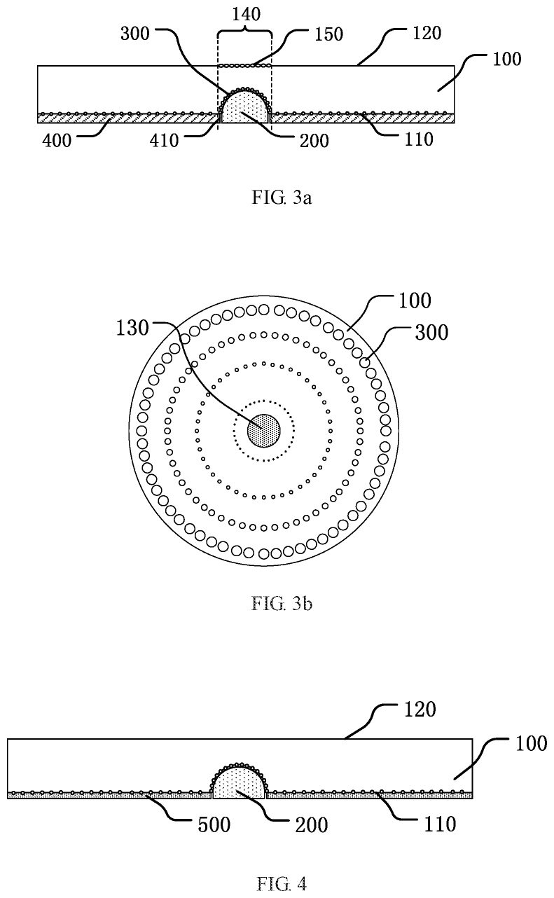

FIG. 3a is another structural schematic diagram of a backlight module provided by an embodiment of the present disclosure. For example, in at least one embodiment of the present disclosure, as shown in FIG. 3a, a plurality of dots 300 may be disposed on the first main surface of the light guide plate 100 and/or the surface of the groove 130. The dots 300 can increase scattering of light, so that the light can more uniformly emerge from the second main surface 120 of the light guide plate 100. For example, the dots 300 may be formed by printing on the first main surface 110 of the light guide plate 100 and/or the surface of the groove 130; and a film layer with the dots 300 may also be bonded to the first main surface 110 of the light guide plate 100 and/or the surface of the groove 130.

In a process that the light emitted by the light-emitting unit 200 is transmitted in the light guide plate 100, brightness of the light may be attenuated, and FIG. 3b is a schematic diagram of distribution of the dots in the backlight module as shown in FIG. 3a on the light guide plate. For example, as shown in FIG. 3b, in at least one embodiment of the present disclosure, diameters of the dots 300 on the first main surface 110 of the light guide plate 100 increase as distances from the groove 130 increase; and for example, in at least one embodiment of the present disclosure, a distribution density of the dots 300 on the first main surface 110 increases as the distances from the groove 130 increase. Both the above-mentioned arrangement modes of the dots 300 can improve uniformity of light emission of the light guide plate 110, and the two modes may also be combined with each other.

In a direction perpendicular to the second main surface 120 of the light guide plate 100, a position on the light guide plate 100, where the groove 130 is formed, is small ill thickness, and after the light-emitting unit 200 emits light, brightness of a position on the light guide plate 100, which corresponds to the groove 130, may be excessively large, so that uniformity of light emission of the light guide plate 100 may be affected and finally, a display effect of a display product is affected.

For example, in at least one embodiment of the present disclosure, as shown in FIG. 3a and FIG. 3b, a distribution density of the dots 300 on the surface of the groove 130 may be set to be greater than that of the dots 300 on the first main surface 110, so that the dispersion degree of the light emitted by the light-emitting unit 200 when the light enters the light guide plate 100 can be improved, and brightness of a central region 140 (a portion of the light guide plate 100, which corresponds to the groove 130) of the light guide plate 100 can be reduced.

For example, in at least one embodiment of the present disclosure, the central region 140 of the second main surface 120 of the light guide plate 100 may be subjected to atomization processing. As shown in FIG. 3a and FIG. 3b, a concave-convex structure 150 may be arranged at a position on the second main surface 120 of the light guide plate 100, which is opposite to the groove 130. The concave-convex structure 150 may reflect portion of light and increase the scattering degree of the light, so that light emerging from the central region 140 (a region where the concave-convex structure is positioned) of the light guide plate 100 can be reduced, the brightness of the central region 140 is reduced, and uniformity of light emission of the light guide plate 100 is improved. It should be noted that the concave-convex structure 150 is not limited to be arranged in the central region 140 as shown in FIG. 3a and FIG. 3b, the specific distribution range of the concave-convex structure 150 may be set according to actual demands, and at least one embodiment of the present disclosure does not make any limit thereto.

In at least one embodiment of the present disclosure, in order to ensure that the light emitted by the light-emitting unit 200 emerges from the second main surface 120 of the light guide plate 100, a structure which can reflect light needs to be arranged on a side of the first main surface 110 of the light guide plate 100.

For example, in at least one embodiment of the present disclosure, as shown in FIG. 3a, the backlight module may further include a reflection layer 400 arranged on a side of the first main surface 110 of the light guide plate 100. The reflection layer 400 may reflect the light in the light guide plate 100 so as to improve an emission rate of the light from the second main surface 120 of the light guide plate 100. For example, in at least one embodiment of the present disclosure, at least one opening 410 is formed in the reflection layer 400, and the opening 410 is set to expose the groove 130, so that the light-emitting unit 200 may be installed in the groove 130 through the opening 410, thereby reducing the difficulty in installing the light-emitting unit 200 and also facilitating arranging a circuit wire connected with the light-emitting unit 200. For example, an orthographic projection of the opening 410 on the second main surface 120 is at least partially overlapped with that of the groove 130 on the second main surface 120.

For example, in at least one embodiment of the present disclosure, FIG. 4 is yet another structural schematic diagram of a backlight module provided by an embodiment of the present disclosure. As shown in FIG. 4, the backlight module may further include an adhesive layer 500 arranged on a side of the first main surface 110 of the light guide plate 100, and a refractive index of the adhesive layer 500 is lower than that of the light guide plate 100, so that the light in the light guide plate 100 is totally reflected when being propagated to an interface of the light guide plate 100 and the adhesive layer 500. Therefore, the reflection layer 400 does not need to be arranged, and a thickness of the adhesive layer 500 is smaller than that of the reflection layer 400, so that the thickness of the backlight module can be reduced, and lightening and thinning of the final display product are improved. It should be noted that in at least one embodiment of the present disclosure, the specific refractive indexes of the light guide plate 100 and the adhesive layer 500 are not limited, as long as a difference between the refractive indexes of the light guide plate 100 and the adhesive layer 500 may enable most of light in the light guide plate 100 to be totally reflected at the interface of the light guide plate 100 and the adhesive layer 500. For example, in at least one embodiment of the present disclosure, the refractive index range of the light guide plate 100 may be 1.4 to 1.6, and the refractive index range of the adhesive layer 500 may be 1.15 to 1.35.

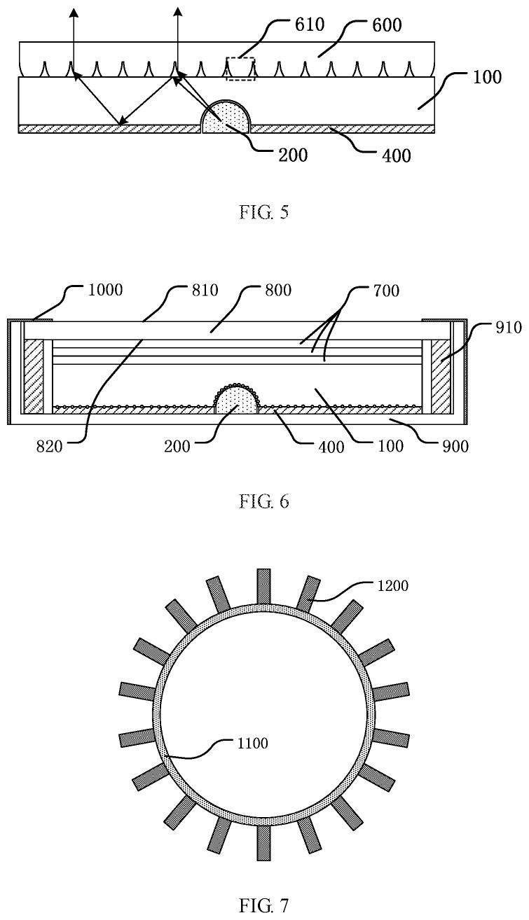

It should be noted that in at least one embodiment of the present disclosure, it is not limited to arrange the dots 300 for ensuring uniformity of light emission of the light guide plate 100. FIG. 5 is still a further structural schematic diagram of a backlight module provided by an embodiment of the present disclosure. For example, as shown in FIG. 5, in at least one embodiment of the present disclosure, a light extraction film 600 is arranged on a side of the second main surface 120 of the light guide plate 100. The light extraction film 600 includes a plurality of microprotrusion structures 610, and a refractive index of the microprotrusion structure 610 may be approximate to or greater than that of the light guide plate 100, so that the light in the light guide plate 100 can enter the light extraction film 600 through the microprotrusion structure 610. For example, a shape of a cross section of the microprotrusion structure 610 in the light extraction film 600 may be set as an arc shape, so that the light is continuously totally reflected in the microprotrusion structure 610 and a propagation direction of the light tends to be a direction perpendicular to surface where the light guide plate 100 is positioned. By regulating distribution and a size of the microprotrusion structures 610 in the light extraction film 600, uniformity of light emission of the light guide plate 100 can be regulated. Exemplarily, the greater an arrangement density of the microprotrusion structures 610 in a region is, the more there is light emerging from the light guide plate 100 in the region; and moreover, the larger the size of the microprotrusion structures 610 (for example, an area of a surface of the microprotrusion structure 610, which faces the light guide plate) is, the more the light which may be exported by the microprotrusion structures 610 is. An arrangement mode of the microprotrusion structures 610 may refer to the specific arrangement mode of the dots 300 in the above-mentioned embodiments, and the embodiments of the present disclosure does not repeat it herein.

At least one embodiment of the present disclosure provides a display apparatus. The display apparatus includes the backlight module in any one of the above-mentioned embodiments.

FIG. 6 is a structural schematic diagram of a display apparatus provided by an embodiment of the present disclosure. For example, as shown in FIG. 6, the display apparatus may include a display panel 800 arranged on a light emergent side of the backlight module, the display panel 800 includes an upper surface 810 and a lower surface 820 which are opposite, and the lower surface 820 of the display panel 800 faces the backlight module. In the embodiments of the present disclosure, the specific shape of the display panel 800 is not limited, the specific shape of the display panel 800 may refer to the specific shape of the light guide plate 100 in the backlight module in the above-mentioned embodiments, and the embodiments of the present disclosure does not repeat it herein.

For example, the display apparatus may be a liquid crystal display apparatus, the display panel 800 in the display apparatus may be a liquid crystal display panel and includes an array substrate and an opposed substrate, the array substrate and the opposed substrate are opposed to each other to form a liquid crystal cell, and the liquid crystal cell is filled with a liquid crystal material. The opposed substrate, for example, is a color filter substrate. A pixel electrode of each pixel unit of the array substrate is used for applying an electric field to control on a rotation degree of the liquid crystal material so as to carry out a display operation.

For example, in at least one embodiment of the present disclosure, as shown in FIG. 6, structures of an optical film sheet 700 and the like may be arranged between the backlight module and the display panel 800 of the display apparatus. The optical film sheet 700, for example, may include structures of a prism film, a diffusion film and the like, so as to regulate a propagation angle of the light emerging from the second main surface 120 of the light guide plate 100.

For example, in at least one embodiment of the present disclosure, as shown in FIG. 6, the display apparatus may further include a backplate 900 for supporting the backlight module and the display panel 800. The backplate 900 may be arranged on a side of the backlight module away from the display panel 800, and may also be set into a U-shaped structure as shown in FIG. 6, and the embodiments of the present disclosure do not limit the specific structure of the backplate 900, as long as the backplate 900 may support the backlight module and the display panel 800. A preparation material of the backplate 900, for example, may be PET in a nontransparent state and the like, or may be PET in a transparent state, and the backplate 900 may be coated with a light shielding paint and the like. For example, the display apparatus may further include a sealant 910, the sealant 910, for example, may be set to connect the display panel 800 with the backplate 900 so as to clamp structures of the backlight module, the optical film sheet 700 and the like between the display panel 800 and the backplate 900.

For example, in at least one embodiment of the present disclosure, FIG. 7 is a structural schematic diagram of a light shielding tape in the display apparatus as shown in FIG. 6, and is a plane schematic diagram of the light shielding tape in an expanded state. For example, as shown in FIG. 6 and FIG. 7, the display apparatus may further include the light shielding tape 1000 for fixing structures of the display panel 800, the backlight module and the like, the light shielding tape 1000 may include a ring-shaped main body 1100 and a plurality of side portions 1200 connected with an outer edge of the main body 1100 and arranged at intervals, the main body 1100 is bonded to an edge portion of the upper surface 810 of the display panel 800, and the side portions 1200 are bonded to the backplate 900. Taking a case that the light guide plate 100 and the display panel 800 are of a circle shape as an example, the main body 1100 of the light shielding tape 1000 may also be set as a circular ring shape, so that the circular-ring-shaped main body 1100 may cover an edge of the display panel 800 to carry out light shielding; and the side portions 1200 of the light shielding tape 1000 are arranged at intervals, and thus, after being bonded to the backplate 900, the side portions 1200 cannot generate wrinkles. For example, the light shielding tape 1000 may be formed by a black material or other opaque material so as to carry out light shielding on a side surface or a non-display region (for example, an edge region of the display panel 800) of the display apparatus. For example, an interval distance between the adjacent side portions 1200 of the light shielding tape 1000 may be set as that: after being bonded to the backplate 900, the side portions 1200 may cover the side surface of the display apparatus.

It should be noted that in at least one embodiment of the present disclosure, the specific shape of the main body 1100 of the light shielding tape 1000 and distribution of the side portions 1200 may be set according to the specific shapes of the light guide plate 100 and the display panel 800, and are not limited to the circle shape as shown in FIG. 6 and FIG. 7; and moreover, in a case that the backplate 900 is only arranged on a side of the backlight module away from the display panel 800, the side portions 1200 of the light shielding tape 1000 may be set to be at least partially bonded to the side surface of the display apparatus, or may also be set to be partially bonded to the backplate 900. With respect to illustration on the specific shapes of the light guide plate 100 and the display panel 800, it may refer to related illustration in the above-mentioned embodiments, and the embodiments of the present disclosure do not repeat it herein.

For example, a display apparatus provided by at least one embodiment of the present disclosure may further include structures of a display drive unit, a power supply unit or a touch unit and the like. For example, the display apparatus may be a device or equipment with a display function, such as a display, a tablet personal computer, a mobile phone, a television, a camera, a navigation device and the like.

At least one embodiment of the present disclosure provides the backlight module and the display apparatus, and may have at least one of the beneficial effects below:

(1) At least one embodiment of the present disclosure provides a backlight module, in the backlight module, the light-emitting unit is arranged in a groove in a light guide plate, and the backlight module with the structure can reduce the number of the light-emitting units being used, improve the utilization rate of light emitted by the light-emitting unit and reduce power consumption.

(2) In a backlight module provided by at least one embodiment of the present disclosure, a light-emitting unit is arranged in a groove of a light guide plate and does not need to additionally occupy a space in the backlight module, so that a thickness of the backlight module can be reduced.

The following statements should be noted:

(1) The accompanying drawings involve only the structure(s) in, connection with the embodiment(s) of the present disclosure, and other structure(s) can be referred to common design(s).

(2) For the purpose of clarity, in accompanying drawings for illustrating the embodiment(s) of the present disclosure, the thickness of a layer or a region may be enlarged or reduced, that is, the accompanying drawings are not drawn according to the actual scale.

(3) In case of no conflict, embodiments of the present disclosure or features in one embodiment or in different embodiments can be combined.

What are described above is related to the specific embodiments of the disclosure only and not limitative to the scope of the disclosure. The protection scope of the disclosure shall be based on the protection scope of the claims.

1. A backlight module, comprising:
a light guide plate, including a first main surface and a second main surface being opposite to each other; and
at least one light-emitting unit, arranged on a side of the first main surface of the light guide plate,
wherein at least one groove is disposed on a side of the light guide plate positioned on the first main surface, and at least one light-emitting unit is arranged in each of the groove.

2. The backlight module according to claim 1, wherein a shape of the light guide plate is one of circle, triangle, rectangle and polygon.

3. The backlight module according to claim 1, wherein one of the grooves is disposed at a shape center of the light guide plate; and/or
at least two of the grooves are symmetrically disposed with respect to the shape center of the light guide plate.

4. The backlight module according to claim 1,
wherein the light guide plate is of a circle shape, and the groove is positioned at a circle center of the first main surface of the light guide plate.

5. The backlight module according to claim 1, wherein in a direction perpendicular to the first main surface, a shape of a cross section of the groove is a circular arc or an elliptic arc.

6. The backlight module according to claim 1, wherein the light-emitting unit is a Light-Emitting diode (LED).

7. The backlight module according to claim 1, further comprising:
a plurality of dots, disposed on the first main surface of the light guide plate and/or a surface of the groove.

8. The backlight module according to claim 7, wherein
diameters of the plurality of dots on the first main surface increase as distances from the groove increase; and/or
a distribution density of the plurality of dots on the first main surface increases as the distances from the groove increase.

9. The backlight module according to claim 7, wherein a distribution density of the dots on the surface of the groove is greater than a distribution density of the dots on the first main surface.

10. The backlight module according to claim 1, wherein a concave-convex structure is arranged at a position on the second main surface of the light guide plate being opposite to the groove.

11. The backlight module according to claim 1, further comprising:
a reflection layer, arranged on a side of the first main surface of the light guide plate,
wherein the reflection layer is provided with at least one opening, and the opening is configured to exposed the groove.

12. The backlight module according to claim 1, further comprising:
an adhesive layer, arranged on a side of the first main surface of the light guide plate,
wherein a refractive index of the adhesive layer is lower than a refractive index of the light guide plate.

13. A display apparatus, comprising the backlight module according to claim 1.

14. The display apparatus according to claim 13, further comprising:
a display panel, arranged on a light emergent side of the backlight module,
wherein the display panel includes both a lower surface and an upper surface opposite to each other, and the lower surface of the display panel faces the backlight module.

15. The display apparatus according to claim 14, further comprising:
a backplate, configured to support the backlight module and the display panel; and
a light shielding tape, configured to fix the display panel and the backlight module,
wherein the light shielding tape includes a ring-shaped main body and a plurality of side portions connected with an outer edge of the main body and arranged at intervals, the main body is bonded to an edge portion of an upper surface of the display panel, and the side portions are bonded to the backplate.

16. The backlight module according to claim 2, further comprising:
a plurality of dots, disposed on the first main surface of the light guide plate and/or a surface of the groove.

17. The backlight module according to claim 3, further comprising:
a plurality of dots, disposed on the first main surface of the light guide plate and/or a surface of the groove.

18. The backlight module according to claim 4, further comprising:
a plurality of dots, disposed on the first main surface of the light guide plate and/or a surface of the groove.

19. The backlight module according to claim 5, further comprising:
a plurality of dots, disposed on the first main surface of the light guide plate and/or a surface of the groove.

20. The backlight module according to claim 6, further comprising:
a plurality of dots, disposed on the first main surface of the light guide plate and/or a surface of the groove.
